(19) United States
(12) Patent Application Publication
(10) Pub. No.: US 2015/0222456 A1
(43) Pub. Date: Aug. 6, 2015

(54) THROUGHPUT SCALING IN A RECEIVER

(71) Applicant: MagnaCom Ltd., Petach Tikva (IL)

(72) Inventors: Amos Intrater, Even Yehuda (IL); Amir Eliaz, Moshav Ben Shemen (IL)

(21) Appl. No.: 14/686,254

(22) Filed: Apr. 14, 2015

Related U.S. Application Data
(63) Continuation of application No. 14/261,801, filed on Apr. 25, 2014.
Application No. 14/261,801 is a continuation-in-part of application No. 14/287,258, filed on May 27, 2014.
Application No. 14/287,258 is a continuation of application No. 13/921,710, filed on Jun. 19, 2013, now Pat. No. 8,737,458.
(60) Provisional application No. 61/662,085, filed on Jun. 20, 2012.
(60) Provisional application No. 61/726,774, filed on Nov. 15, 2012.
(60) Provisional application No. 61/729,774, filed on Nov. 26, 2012.
(60) Provisional application No. 61/747,123, filed on Dec. 28, 2012.
(60) Provisional application No. 61/768,532, filed on Feb. 24, 2013.
(60) Provisional application No. 61/807,813, filed on Apr. 3, 2013.

(51) Int. Cl. H04L 25/03; H04L 1/00; H04L 27/28

(52) U.S. Cl. CPC H04L 25/03178; H04L 27/28; H04L 1/0054

(57) ABSTRACT

A receiver comprises a plurality of sequence estimation circuits. The receiver receives a signal that comprises a plurality of frames. For each one of the frames, the receiver samples the received signal resulting in a first plurality of samples corresponding to a preamble of the one of the frames and a second plurality of samples corresponding to a plurality of symbols of the one of the frames. A value of each sample of the second plurality of samples depends on several of the symbols of the one of the frames. The receiver splits the signal at preambles of the frames and demultiplexes the frames to generate a plurality of signals. The receiver may process the signals in parallel. The processing may comprise resetting of a state of each of the plurality of sequence estimation circuits upon detection of each preamble in a respective one of the plurality of signals.

### PRIORITY CLAIM

This application is a continuation of U.S. patent application Ser. No. 14/261,801 filed on Apr. 25, 2014, and a continuation-in-part of U.S. patent application Ser. No. 14/287,258 filed on May 27, 2014 (published as 2014/0121525). U.S. patent application Ser. No. 14/287,258 is in turn a continuation of U.S. patent application Ser. No. 13/921,710 filed on Jun. 29, 2013 (U.S. Pat. No. 8,737,458). U.S. patent application Ser. No. 13/921,710 in turn claims priority to U.S. provisional patent application 61/662,085 filed on Jun. 20, 2012; U.S. provisional patent application 61/726,774 filed on Nov. 14, 2012; U.S. provisional patent application 61/729,774 filed on Nov. 26, 2012, U.S. provisional patent application 61/747,123 filed on Dec. 28, 2012, U.S. provisional patent application 61/768,532 filed on Feb. 24, 2013, and U.S. provisional patent application 61/807,813 filed on Apr. 3, 2013. Each of the above applications and publications is hereby incorporated herein by reference.

### INCORPORATION BY REFERENCE

The entirety of each of the following applications is hereby incorporated herein by reference:

U.S. Pat. No. 8,582,637 titled “Low-Complexity, Highly-Spectrally-Efficient Communications” filed on Jan. 31, 2013;
U.S. Pat. No. 8,666,000 titled “Reduced State Sequence Estimation with Soft Decision Outputs” filed on Jun. 20, 2013
U.S. Pat. No. 8,781,008 titled “Highly-Spectrally-Efficient Transmission Using Orthogonal Frequency Division Multiplexing” filed on Jun. 19, 2013; and
U.S. Pat. No. 8,737,458 titled “Highly-Spectrally-Efficient Reception Using Orthogonal Frequency Division Multiplexing” filed on Jun. 19, 2013.

### BACKGROUND

Limitations and disadvantages of conventional approaches to signal reception will become apparent to one of skill in the art, through comparison of such approaches with some aspects of the present method and system set forth in the remainder of this disclosure with reference to the drawings.

### BRIEF SUMMARY

Methods and systems are provided for throughput scaling in a receiver, substantially as illustrated by and/or described in connection with at least one of the figures, as set forth more completely in the claims.

### BRIEF DESCRIPTION OF THE DRAWINGS

FIG. 1A is a simplified block diagram of a transmitter operable to generate signals having inter-symbol and/or inter-carrier correlation.

FIG. 1B is a simplified block of a receiver operable to receive, with scalable throughput, signals transmitted by the transmitter of FIG. 1A

FIG. 2 is a simplified block diagram of an example implementation of each of the RSSE engines of FIG. 1B.

FIG. 3 is a timing diagram illustrating frame parallelization in the receiver of FIG. 1B.

FIG. 4 illustrates example implementations in which the digital front-end circuit adds symbols during splitting of a received signal.

FIG. 5 is a simplified block diagram of another example implementation of the RSSE engines of FIG. 1B.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

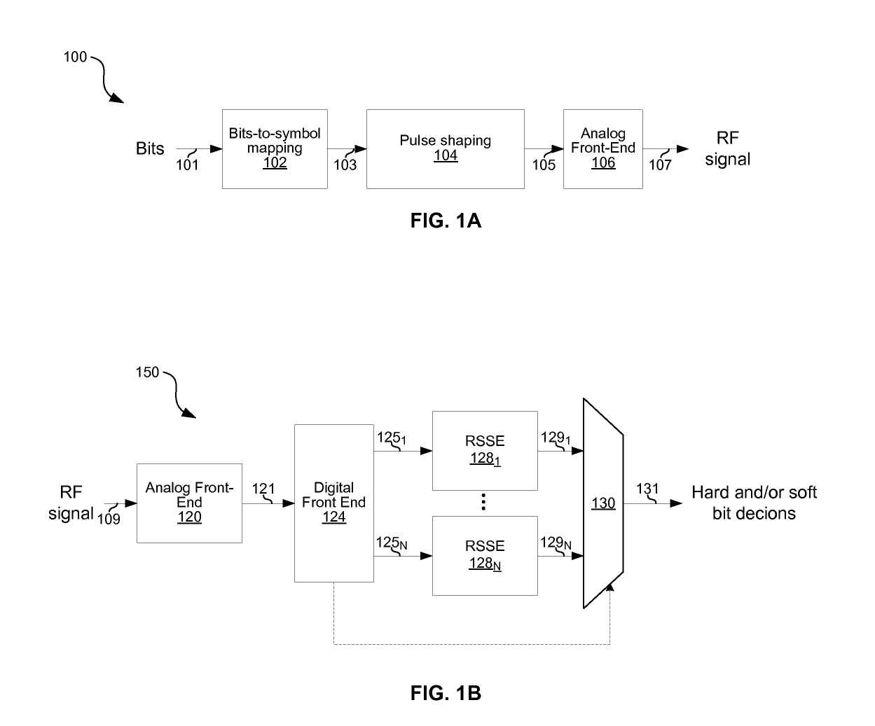

FIG. 1A is a simplified block diagram of a transmitter operable to generate signals having inter-symbol and/or inter-carrier correlation. The transmitter 100 comprises a bits-to-symbols mapping circuit 102, a pulse shaping circuit 104, and an analog front-end circuit 106.

The bits-to-symbols mapping circuit 102 is operable to map bits of the signal 101 to symbols according to a selected modulation scheme. The signal 101 may, for example, be the result of bits of data passing through a forward error correction (FEC) encoder and/or an interleaver. The result of the mapping is signal 103, which may have a sample rate equal to or higher than the symbol rate. As an example, for a quadrature amplitude modulation scheme having a symbol alphabet of N (N-QAM), the mapper may map each Log₂(N) bits of signal 101 to a single symbol represented as a complex number and/or as in-phase (I) and quadrature-phase (Q) components. Although N-QAM is used for illustration in this disclosure, aspects of this disclosure are applicable to any modulation scheme (e.g., amplitude shift keying (ASK), phase shift keying (PSK), frequency shift keying (FSK), etc.). Additionally, points of the N-QAM constellation may be regularly spaced (“on-grid”) or irregularly spaced (“off-grid”). Furthermore, the symbol constellation used by the mapper may be optimized for best bit-error rate performance that is related to log-likelihood ratio (LLR) and to optimizing mean mutual information bit (MMIB). Although not shown, the signal 103 may be processed by an interleaver.

The pulse shaping circuit 104 is operable to process the signal 103 to generate a signal 105 that complies with a spectral mask. Conventional transmitters typically achieve this through use of a root raised cosine (RRC) filter. The RRC filter is typically used because, when the resulting signal is received by a receiver that has an RRC matched filter and samples the received signal at carefully controlled time instants, the result is zero (or negligible) inter-symbol interference (ISI). In contrast to such conventional transmitters, the pulse shaping circuit 104 may result in a pulse shape for which ISI cannot be eliminated (or made negligible) simply by carefully controlling the sampling time instants. In fact, for the pulse shaping circuit 104 the ISI (i.e., correlation among symbols) is desired and taken advantage of to improve performance.

In a single-carrier implementation, the correlation may be in the time domain. That is, the correlation may be among successive symbols in the time domain, with the correlation occasionally or periodically terminated/reset through insertion of preamble symbols. In an example single-carrier implementation, the circuit 104 comprises components 104 and 105 of the above-incorporated U.S. Pat. No. 8,582,637.

In a multi-carrier implementation, the correlation may be in the frequency domain. That is, the correlation may be among sub-symbols output on a plurality of OFDM subcarriers of a particular OFDM symbol. In an example multi-carrier implementation, the circuit 104 comprises components 104, 108, 110, 112, 114, and 116 of the above-incorporated U.S. Patent Application Publication 2013/0343473.

The front-end circuit 106 is operable to amplify and/or upconvert the signal 105 to generate the transmitted RF signal 107. Thus, the front-end circuit 106 may comprise, for example, a power amplifier and/or a mixer. The front-end may introduce nonlinear distortion, phase noise, and/or other non-idealities to the transmitted RF signal 107. The nonlinearity of the circuit 106 may be represented as FnlTx which may be, for example, a polynomial or an exponential (e.g., Rapp model). The nonlinearity may incorporate memory (e.g., Voltera series).

In operation, a frame of bits of signal 101 is mapped, by circuit 102, to a frame of symbols of signal 103. The signal 103 is then processed by circuit 104 to generate a frame of samples of signal 105. A result of the processing by circuit 104 may be that the signal 105 complies with an applicable spectral mask (e.g., set forth by a governmental body). A result of the processing by circuit 104 may be that a value of each sample of the frame of samples of signal 105 depends on multiple (perhaps all) of the symbols in the frame. That is, for a single-carrier implementation, each symbol is spread in the time domain over multiple (perhaps all) of the symbol samples of the frame. For a multi-carrier implementation, each symbol is spread in the frequency domain over multiple (perhaps all) of the samples of the frame. The pulse shaping circuit 104 may insert a preamble at the beginning of each frame of signal 105. In this manner, the signal 105 may comprise a series of frames where each frame comprises a plurality of intercorrelated samples corresponding to a preamble and a plurality of data symbols. The signal 105 is then upconverted and amplified by analog front-end 106 resulting in the signal 107.

FIG. 1B is a simplified block of a receiver operable to receive, with scalable throughput, signals transmitted by the transmitter of FIG. 1A.

As discussed above, with conventional QAM signals using RRC pulse shaping filters at the transmitter and receiver, sampling the received signal at the proper time can eliminate (or make negligible) correlation between successive samples of the received signal. As a result, simple symbol slicing may be used to recover the symbols of the conventional QAM signal. Conversely, for the signal 107 output by the transmitter 100, a value of the received signal 109 (corresponding to the signal 107 plus noise introduced by the channel) at any given sampling instant will depend on multiple (perhaps all) of the symbols of the current frame of the signal 109. Recovery of the symbols carried in signal 109 can therefore be performed much more accurately using sequence estimation rather than simply slicing one symbol at a time.

One issue with sequence estimation is that the number of possible sequences can be huge for even moderately-sized symbol constellations and memory depth. To deal with this complexity, an example implementation of this disclosure may reduce the number of historical sequences to a small set of the most-likely sequences for each symbol. In such an implementation, for each symbol of the received signal, the sequence estimation processing comprises generating many symbol candidates and then reducing those many candidates down to a subset of most-likely candidates. The fact that the reduction in the number of candidates must occur before processing of the next symbol can begin combined with the fact that sequence estimation generally takes longer than symbol-by-symbol slicing, can introduce significant limits on achievable throughput. Accordingly, aspects of this disclosure provide methods and systems for overcoming these obstacles and increasing the throughput when processing a signal such as signal 109. Furthermore, the achievable throughput through use of the methods and systems of this disclosure is scalable based on cost/performance requirements of any particular implementation.

The example receiver 150 comprises an analog front-end circuit 120, a digital front-end circuit 124, a plurality of RSSE circuits 128 configured in parallel with one another, a multiplexer 130, and a symbol-to-bits demapping circuit 132.

The analog front-end circuit 120 is operable to process the signal 109 to generate a corresponding digital signal 121. The processing may comprise, for example, amplification, filtering, and downconversion to baseband.

The digital front-end circuit 124 is operable to split the signal into signals 121₁-121_{N}, where N is a positive integer greater than 1. The digital front-end circuit 124 may also be operable to perform signal conditioning functions such as, for example, adaptive gain control, frequency correction, I/Q mismatch correction, and timing correction. In various implementations, whether one or more of these signal conditioning functions is/are implemented in the digital front-end circuit 124 or in one or more of the RSSE circuits 128 may be determined based on cost and performance considerations. In an example implementation, signal processing operations in the digital front-end circuit 124 may be such that each symbol can be processed independently. In such an implementation, the processing may be pipelined on a symbol-by-symbol basis.

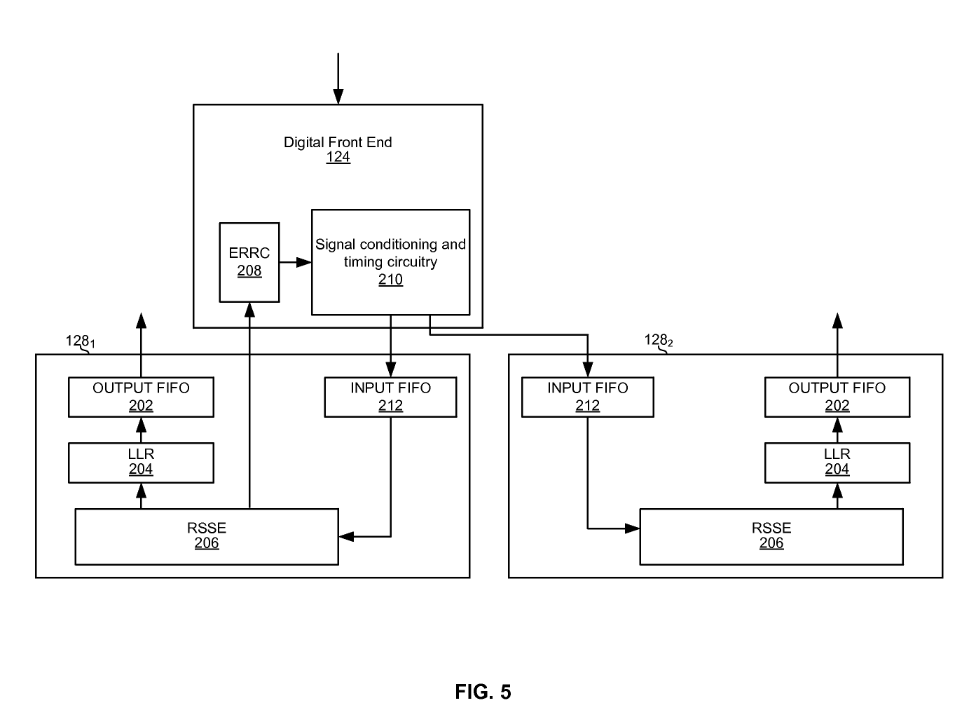

Each RSSE circuit 128ₙ is operable to perform reduced state sequence estimation to recover data from the received signal 109 on a frame-by-frame basis. Here “reduced state” means that, for demodulating a sequence of X (an integer) symbols, fewer than all of the 2^{x} possibilities are evaluated, thus reducing size and complexity of the circuit 128 at the expense of certainty. Each RSSE circuit 128ₙ may also be operable to perform signal conditioning functions such as, for example, equalization (e.g., via a feed forward equalizer), phase correction, and signal bias correction. In various implementations, whether one or more of these signal conditioning functions is/are implemented in the RSSE circuit 128ₙ or in the digital front-end circuit 124 may be determined based on cost and performance considerations. In this regard, implementing functions such as equalization and phase correction once in the digital front-end circuit 124 (as shown in FIG. 5B, for example) may, for example, save space and/or power at the expense of slower feedback loops which may negatively impact demodulation performance, whereas implementing such functions multiple times in the plurality of RSSE circuits 128₁-128_{N} may, for example, provide faster feedback loops for improved performance at the expense of larger size and higher cost.

The multiplexer 130 multiplexes the signals 129₁-129_{N} into the single signal 131.

In operation, signal 109 is processed by analog front-end circuit 120 to generate digital baseband signal 121. The digital front-end circuit 124 performs any desired or necessary conditioning of the signal 121 and then splits the signal into signals 125₁-125_{N}. The splitting (or demultiplexing) may be performed to ensure correlated groups of samples remain together such that reliable sequence estimation can be performed. For example, in an example implementation where the samples of any given frame depend on all the symbols of that frame (where, for OFDM, a frame may correspond to an OFDM symbol plus a preamble), the splitting may be done at frame boundaries, with each split triggered by detection of a preamble in the signal 121. In such an implementation, the frames of the signal 121 may be demultiplexed onto the signals 125₁-125_{N} on a frame-by-frame basis. Each RSSE circuit 128ₙ buffers its respective signal 125ₙ, and then performs reduced state sequence estimation on the group of samples to generate hard and/or soft-decisions as to the transmitted bits that resulted in that group of samples. The bit decisions of each RSSE circuit 128ₙ are output as signal 129ₙ. The decisions may be buffered until a frame's worth of decisions are available and then burst out to the multiplexer 130, which then multiplexes the bit decision frames from circuits 128₁-128_{N} onto the signal 131.

In an example implementation, the signal 109 is received via a wired, optical, and/or wireless medium that introduces additive white Gaussian noise (AWGN). The signal 109 may also be distorted by nonlinear distortion introduced by the analog front-end 106, the medium, and/or the analog-front end 120. The impact of the AWGN and nonlinear distortion may be characterized by the signal to noise and distortion power ratio (SINAD) of the signal 121.

For any particular modulation scheme that may comprise symbol constellation and encoding used by the transmitter 100 to generate signal 107, there may be a limit on how low the signal to noise power ratio (SNR) of the received signal 121 can be to assure certain decoding performance of receiver 150. This SNR is referred to as the receiver threshold SNR. For example, the threshold SNR may be the minimum SNR required to achieve a symbol error rate equal to 1e⁻², or a bit error rate level equal to 1e-6, or packet error rate of 1e-3. In an example implementation, the receiver 150 may be operable to meet the same determined performance as used for measuring the threshold SNR when the SINAD is 6 dB worse than the threshold SNR.

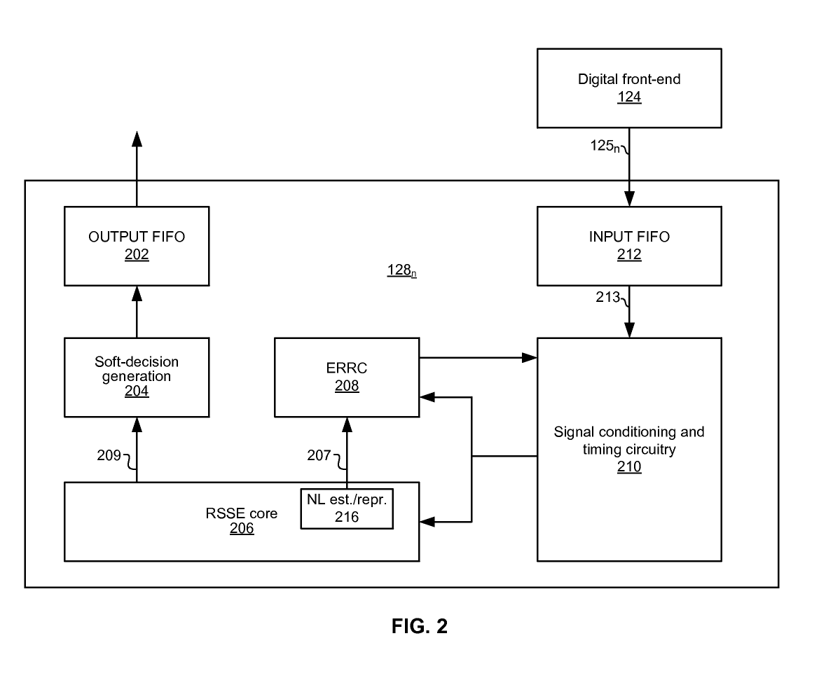

FIG. 2 is a simplified block diagram of an example implementation of each of the RSSE circuits of FIG. 1B. The example RSSE circuit 128ₙ represents any of the RSSE circuit 128₁-128_{N} of FIG. 1B. The RSSE circuit 128ₙ comprises an input first-in-first-out buffer (FIFO) 212, signal conditioning and timing circuitry 210, RSSE core circuitry 206, error calculation circuitry 208, soft decision generation circuitry 204, and output FIFO 202.

The input FIFO 212 is operable to buffer samples from the digital front-end 124 to compensate for the difference between the rate at which the samples of the received signal arrive at the RSSE circuit 128ₙ and the rate at which the RSSE circuit 128ₙ can process the samples. That is, symbols are stored to the FIFO 212 at the symbol rate of the received signal 109 and read out from the FIFO 212 at the processing rate of the RSSE core 206.

The signal conditioning and timing circuitry 210 is operable to condition the signal 213 prior to the signal being operated on by the RSSE core 206. Such conditioning may include, for example, equalization, phase error correction, and signal bias correction. The signal conditioning functions may be adapted based on feedback from the RSSE core 206 via the error calculation circuit 208.

In an example implementation, the signal conditioning and timing circuitry 210 is also operable to determine the phase offset of the symbols received as signal 213. In this regard, as a result of the demultiplexing performed by digital front-end circuit 124, consecutive frames on any signal 125ₙ were nonconsecutive frames of the signal 121. Thus, there may be phase discontinuities at the frame boundaries on the signal 125ₙ. The timing circuitry 210 may be operable to determine the phase of the preamble of each frame on signal 125ₙ, and use that phase as the initial phase for processing the symbols of the frame. In another implementation, phase adaptation may be performed inside the RSSE core 206, eliminating the need for the circuitry 210 to perform phase estimation for each frame.

The RSSE core circuitry 206 may perform reduced state sequence estimation on a frame-by-frame basis. The RSSE core circuitry 206 may output early symbol decisions 207 for closing the feedback loops, and may output a set of symbol survivor vectors 209 to the circuit 204. The RSSE core circuitry 216 comprises nonlinearity estimation/reproduction circuitry 216 operable to model a nonlinearity experienced by the received signal 121 and apply the model to the early symbol decisions 207. The model may be adapted dynamically (e.g., on a frame by frame basis during reception of the signal 209). The adaptation may, for example, using preambles of the signal 209. The sequence estimation and error calculation may be as described, for example, in the above incorporated U.S. Pat. No. 8,582,637. The soft decision generation circuitry 204 may generate soft bit decisions (e.g., in the form of LLRss) based on the symbol survivors 209 output by the RSSE core 206 as, for example, described in the above incorporated U.S. Pat. No. 8,666,000.

The output FIFO 202 buffers the soft decisions from the circuit 204 until they are ready out to the multiplexer 130.

In an example implementation, the signal conditioning and timing circuitry 210, RSSE core 206, and error correction circuitry may correspond to the circuit 112 of the above incorporated U.S. Pat. No. 8,582,637.

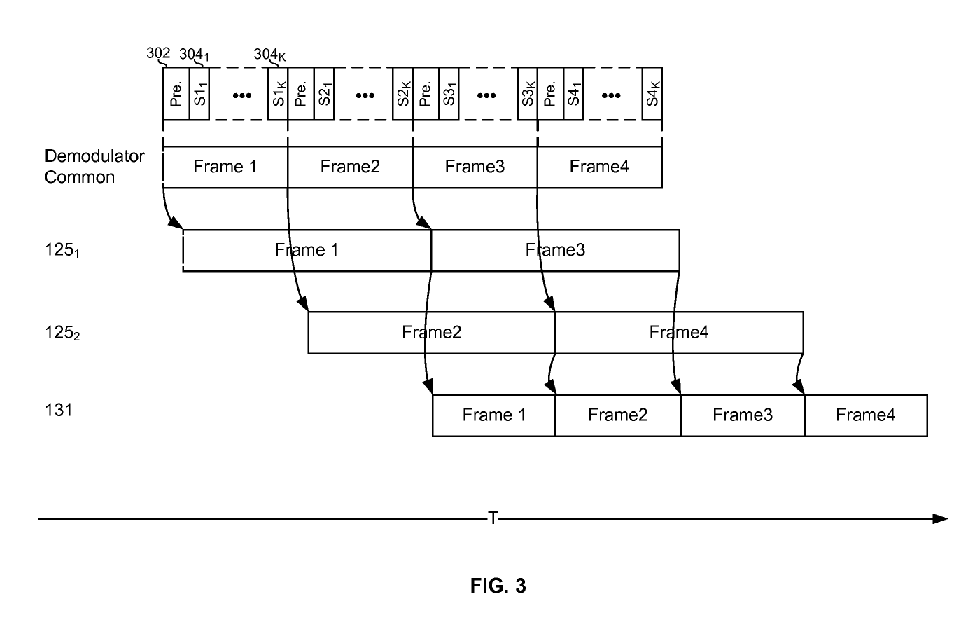

FIG. 3 is a timing diagram illustrating frame parallelization in the receiver of FIG. 1B. Shown are four frames, each comprising a preamble and K (a positive integer) symbols (although the depicted frames are of uniform size, they may be of varying sizes). In the example shown, the frames are demultiplexed into two signals 125₁ and 125₂ for processing by two RSSE circuits 128₁ and 128₂. As a result, frames 1 and 3 are demultiplexed onto signal 125₁ and frames 2 and 4 are demultiplexed onto signal 125₂. After processing in the RSSE circuits 128₁ and 128₂, the frames of demodulated bits are multiplexed into signal 131.

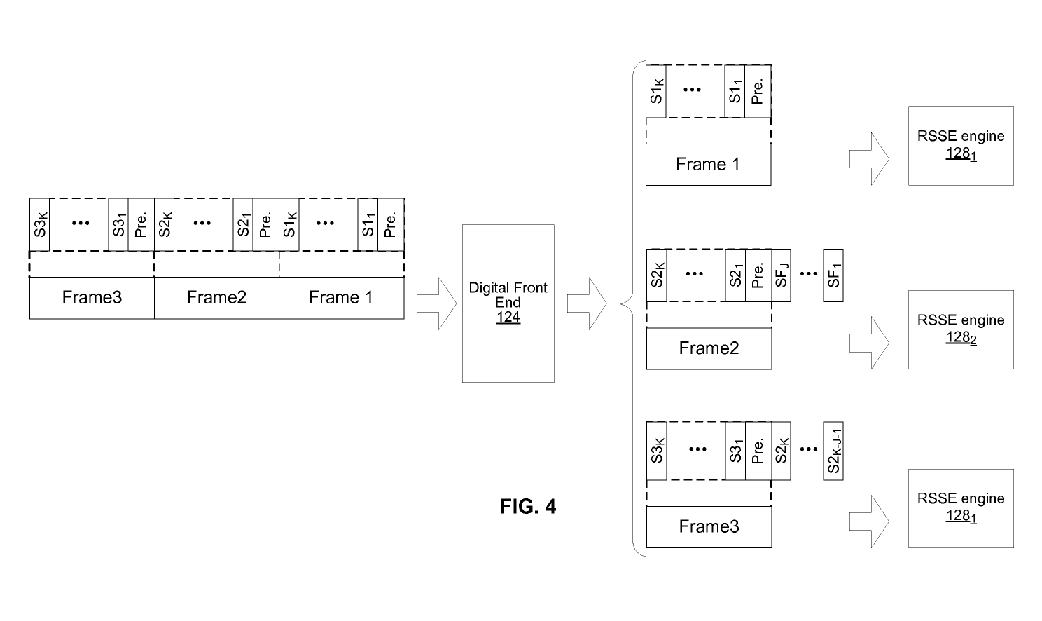

FIG. 4 illustrates example implementations in which the digital front-end circuit inserts symbols during splitting of a received signal.

In an example implementation, during splitting of the signal 121 into N signals, the digital front-end circuit 124 may simply output the frames as-is, without adding any padding. This is shown for frame 1 in FIG. 4.

In an example implementation, during splitting of the signal 121 into N signals, the digital front-end circuit 124 may add fixed and predetermined padding symbols to the frames. This is shown for frame 2 in FIG. 4, with J fixed padding symbols having been added.

In an example implementation, during splitting of the signal 121 into N signals, the digital front-end circuit 124 may add symbols from a previous frame as padding. This is shown for frame 3 in FIG. 4, with the last K symbols of frame 2 having been added.

Although, the symbols are shown as being added to the beginning of the frames, it may be that they are added to the beginning, interior, and/or end of frames.

FIG. 5 is a simplified block diagram of another example implementation of the RSSE circuits of FIG. 1B. FIG. 5 shows an example implementation comprising two RSSE circuits 128₁ and 128₂. In FIG. 5, the error calculation circuit 208 and the signal conditioning and timing circuitry 210 are implemented in the digital front-end circuit 124. In FIG. 5, the adaptive circuitry of the signal conditioning and timing circuitry 210 is fed by feedback from the RSSE circuit 128₁.

In accordance with an example implementation of this disclosure, a receiver (e.g., 150) comprises a plurality of sequence estimation circuits (e.g., 128₁ and 128₂). The receiver may receive a signal (e.g., 109) that comprises a plurality of frames. For each one of the frames, the receiver may sample the received signal resulting in a plurality of samples corresponding to a preamble and plurality of data symbols (e.g., 304₁-304_{K}) of the one of the frames. A value of each sample of the plurality of samples may depend on several of the data symbols of the one of the frames (e.g., each sample of the frame 1 of FIG. 3 may depend on all of the symbols 304₁-304_{K} of frame 1). The receiver may split the signal at preambles of the plurality of frames and demultiplex the plurality of frames to generate a plurality of signals (e.g., 125₁ and 125₂). The receiver may process the plurality of signals in parallel via the plurality of sequence estimation circuits. The processing may comprise resetting a state of each of the plurality of sequence estimation circuits (e.g., the contents of symbol survivors maintained in RSSE core 206, the value of metrics calculated by error calculation circuit 208, phase error values, equalizer tap coefficients, and/or the like) upon detection of each preamble in a respective one of the plurality of signals. Each of the sequence estimation circuits may perform reduced state sequence estimation. A rate at which each of the plurality of sequence estimation circuits is operable to output symbol decisions for the plurality of frames of the received signal may be less than a rate at which the frames of the received signal arrive at the receiver. The receiver may insert, during the splitting, one or more padding symbols to a beginning of each of the plurality of frames. The padding symbols may be fixed-value symbols or may be symbols from a preceding one of the plurality of frames. Resetting the state of a sequence estimation circuit in response to a particular preamble of a particular one of the plurality of frames may comprise determining a phase of the particular preamble, and using the determined phase of the particular preamble as an initial phase for processing symbols of the particular frame (e.g., determining a phase based on preamble 302 of frame 1 and using that determined phase as an initial phase for processing symbols 304₁-304_{K}). The receiver may, in each of the sequence estimation circuits, equalize a respective one of the plurality of signals. The receiver may equalize the received signal prior to the splitting the received signal. The receiver may, in each of the sequence estimation circuits, correct a phase error of a respective one of the plurality of signals. The receiver may correct a phase of the received signal prior to the splitting of the received signal.

The present method and/or system may be realized in hardware, software, or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A method comprising:
in a receiver comprising a plurality of sequence estimation circuits:
receiving a signal that comprises a plurality of frames;
splitting said signal at preambles of said plurality of frames and demultiplexing said plurality of frames to generate a plurality of signals; and
processing said plurality of signals in parallel via said plurality of sequence estimation circuits, wherein said processing comprises:
resetting a state of each of said plurality of sequence estimation circuits upon detecting each preamble in a respective one of said plurality of signals;
generating a model of nonlinearity experienced by said received signal en route to said receiver;
distorting symbol candidates using said model of nonlinearity; and
calculating an error based on said distorted symbol candidates and said received signal.

2. The method of claim 1, comprising:
for each one of said frames, sampling said received signal to generate a plurality of samples corresponding to a plurality of symbols of said one of said frames, wherein a value of each sample of said plurality of samples depends on more than one of said symbols of said one of said frames.

3. The method of claim 1, comprising:
receiving said signal via a channel that introduces additive white Gaussian noise and nonlinear distortion, the combined effects of which result in a signal to noise and distortion power ratio (SINAD) of said received signal that is less than or equal to said receiver's threshold signal to noise power ratio (SNR) plus 6 dB.

4. The method of claim 1, comprising performing, by each of said plurality of sequence estimation circuits, reduced state sequence estimation.

5. The method of claim 4, comprising reproducing, by said plurality of sequence estimation circuits, a nonlinearity experienced by said received signal en route to said receiver.

6. The method of claim 5, comprising dynamically adapting said circuitry for reproducing said nonlinearity based on contents of said received signal.

7. The method of claim 1, comprising generating soft bit decisions from symbol decisions and symbol hypotheses generated by said plurality of sequence estimation circuits.

8. The method of claim 1, comprising outputting, by plurality of sequence estimation circuits, symbol decisions for said plurality of frames of said received signal at a rate is less than a rate at which symbols of said frames of said received signal arrive at said receiver.

9. The method of claim 1, comprising outputting, by said plurality of sequence estimation circuits, bit log-likelihood ratios for said received signal at a rate that is less than a rate at which bits of said received signal arrive at said receiver.

10. The method of claim 1, comprising adding, during said splitting, one or more fixed-value padding symbols to each of said plurality of frames.

11. The method of claim 1, wherein resetting said state in response to a particular preamble of a particular one of said plurality of frames comprises:
determining a phase of said particular preamble; and
using said phase of said particular preamble as an initial phase for processing symbols of said particular frame.

12. The method of claim 1, comprising, in each of said sequence estimation circuits, equalizing a respective one of said plurality of signals.

13. The method of claim 1, comprising equalizing said received signal prior to said splitting said received signal.

14. The method of claim 1, comprising, in each of said sequence estimation circuits, correcting a phase error of a respective one of said plurality of signals.

15. The method of claim 1, comprising correcting a phase of said received signal prior to said splitting of said received signal.

16. A system comprising:
a receiver that comprises a digital front-end circuit and a plurality of sequence estimation circuits, wherein:
said digital front-end circuit is operable to:
receive a signal that comprises a plurality of frames;
split said signal at preambles of said plurality of frames and demultiplex said plurality of frames to generate a plurality of signals; and
said plurality of sequence estimation circuits are operable to:
process said plurality of signals in parallel, wherein said processing of said plurality of signals comprises a resetting of a state of each of said plurality of sequence estimation circuits upon detection of each preamble in a respective one of said plurality of signals;
generate a model of nonlinearity experienced by said received signal en route to said receiver;
distort symbol candidates using said model of nonlinearity; and
calculate an error based on said distorted symbol candidates and said received signal.

17. The system of claim 16, wherein said receiver is operable to:
for each one of said frames, sample said received signal to generate a plurality of samples corresponding to a plurality of symbols of said one of said frames, wherein a value of each sample of said plurality of samples depends on more than one of said symbols of said one of said frames.

18. The system of claim 16, comprising:
receiving said signal via a channel that introduces additive white Gaussian noise and nonlinear distortion, the combined effects of which result in a signal to noise and distortion power ratio (SINAD) of said received signal that is less than or equal to said receiver's threshold signal to noise power ratio (SNR) plus 6 dB.

19. The system of claim 16, wherein each of said sequence estimation circuits is operable to perform reduced state sequence estimation.

20. The system of claim 19, wherein said sequence estimation circuits comprise circuitry operable to reproduce a nonlinearity experienced by said received signal en route to said receiver.

21. The system of claim 20, wherein said circuitry for reproducing said nonlinearity is adapted dynamically based on contents of said received signal.

22. The system of claim 16, wherein said receiver is operable to generate soft bit decisions from symbol decisions generated by said plurality of sequence estimation circuits.

23. The system of claim 16, wherein a rate at which each of said plurality of sequence estimation circuits is operable to output symbol decisions for said plurality of frames of said received signal is less than a rate at which symbols of said frames of said received signal arrive at said receiver.

24. The system of claim 16, wherein a rate at which each of said plurality of sequence estimation circuits is operable to output bit log-likelihood ratios for said received signal is less than a rate at which bits of said received signal arrive at said receiver.

25. The system of claim 16, wherein said digital front-end circuit is operable to add one or more fixed-value padding symbols to each of said plurality of frames.

26. The system of claim 16, wherein reset of a state of one of said sequence estimation circuits in response to a particular preamble of a particular one of said plurality of frames comprises:
a determination of a phase of said particular preamble; and
use, by said one of said sequence estimation circuits, of said phase of said particular preamble as an initial phase for processing of symbols of said particular frame.

27. The system of claim 16, wherein each of said sequence estimation circuits is operable to equalize a respective one of said plurality of signals.

28. The system of claim 16, wherein said digital front-end circuit is operable to equalize said received signal prior to said split of said received signal.
